(19) United States
(12) Patent Application Publication
(10) Pub. No.: US 2009/0061910 A1
(43) Pub. Date: Mar. 5, 2009

(54) WIRELESS MOBILE MESSAGING

(76) Inventor: Sule I. Garba, Shaker Heights, OH (US)

Correspondence Address: DRIGGS, HOGG, DAUGHERTY & DEL ZOPPO CO., L.P.A., 38500 CHARDON ROAD, DEPT. DLBH, WILLOUGBY HILLS, OH, 44094, US

(21) Appl. No.: 11/846,205

(22) Filed: Aug. 28, 2007

(51) Int. Cl. H04Q 7/20

(52) U.S. Cl. 455/466

(57) ABSTRACT

A wireless mobile communication device includes a message assembler that assembles a message using a plurality of sub-messages. Each of the sub-messages is associated with corresponding indicia that indicates at least a type of the sub-message. A preference bank that stores message preferences. At least one of the message preferences indicates a manner in which a sender of the message desires the sub-messages to be presented to a recipient of the message. A message transmitter that transmits the message for receipt by the recipient.

### BACKGROUND

The following generally relates to wireless mobile messaging.

Wireless mobile devices such as cell phones provide various messaging capabilities. When such a device is turned on, it wirelessly registers, via electromagnetic radio waves, with a mobile telephone exchange, or switch, using a unique identifier through a cell site base station. Once registered, a wireless receiver of the device can receive an alert or notification from the switch when there is an incoming wireless message such as a telephone call, a voicemail, a text message, an email, a data packet, a digital image, or an instant message.

A wireless transmitter of the device communicates with the mobile switch. The mobile switch, in turn, connects the communication to another subscriber of the wireless service provider, a private branch exchange (PBX), a public switched telephone network (PSTN), or the like. As the wireless mobile device moves around a network, the wireless mobile telephone will be “handed off” to other cell sites (while the device is communicating with a base station, another subscriber, a PBX, or a PSTN) and when the device is idle, or not communicating as such.

### SUMMARY

In one aspect, a wireless mobile communication device includes a message assembler that assembles a message using a plurality of sub-messages. Each of the sub-messages is associated with corresponding indicia that indicates at least a type of the sub-message. A preference bank that stores message preferences. At least one of the message preferences indicates a manner in which a sender of the message desires the sub-messages to be presented to a recipient of the message. A message transmitter that transmits the message for receipt by the recipient.

In another aspect, a wireless mobile communication device includes a receiver that receives one or more message, each having a plurality of sub-messages. Each of the sub-messages is associated with corresponding indicia that indicates at least a type of the sub-message. A preference bank that stores message preferences, wherein at least one of the message preferences indicates a manner in which the sub-messages are to be presented. A conditioner that conditions the received sub-messages based on the at least one preference. A user interface that presents the conditioned sub-messages.

In another aspect, a method includes generating a message that includes a plurality of independent sub-messages, organizing the sub-messages based on a preference, and wirelessly transmitting the message, using a wireless mobile device, for reception by a recipient.

In another aspect, a method includes receiving a plurality of messages with a wireless mobile device, wherein each of the plurality of messages includes a plurality of sub-messages, identifying one of the plurality of messages, identifying a sub-message of the message for presentation, identifying a presentation preference for the identified sub-message, and presenting the sub-message based on the identified preference.

In another aspect, a computer readable medium includes a message data structure that includes a plurality of messages and a plurality of sub-messages for each of the plurality of messages, wherein the message data structure is wirelessly transmitted by a wireless mobile communication device. The message data structure includes first fields adapted to include data that uniquely identifies reception of one of the plurality of messages, a plurality of sub-message fields corresponding to each of the first fields, wherein each of the plurality of sub-message fields is configured to include a different sub-message, for each of the plurality of sub-message fields, an information field configured to include one or more parameters indicative of the sub-message.

Still further aspects will be appreciated to those of ordinary skill in the art upon reading the following.

### DESCRIPTION OF THE DRAWINGS

FIG. 1 illustrates a non-limiting example of a mobile wireless system.

FIG. 2 illustrates non-limiting example transmitting and receiving portions of the mobile wireless system.

FIG. 3 illustrates a non-limiting example of a message data structure.

FIG. 4 illustrates a non-limiting example flow diagram of mobile wireless communication.

FIG. 5 illustrates a non-limiting example flow diagram of mobile wireless communication.

The drawings are only for purposes of illustrating examples and are not limiting. In the drawings, like numerals represents like elements.

### DETAILED DESCRIPTION

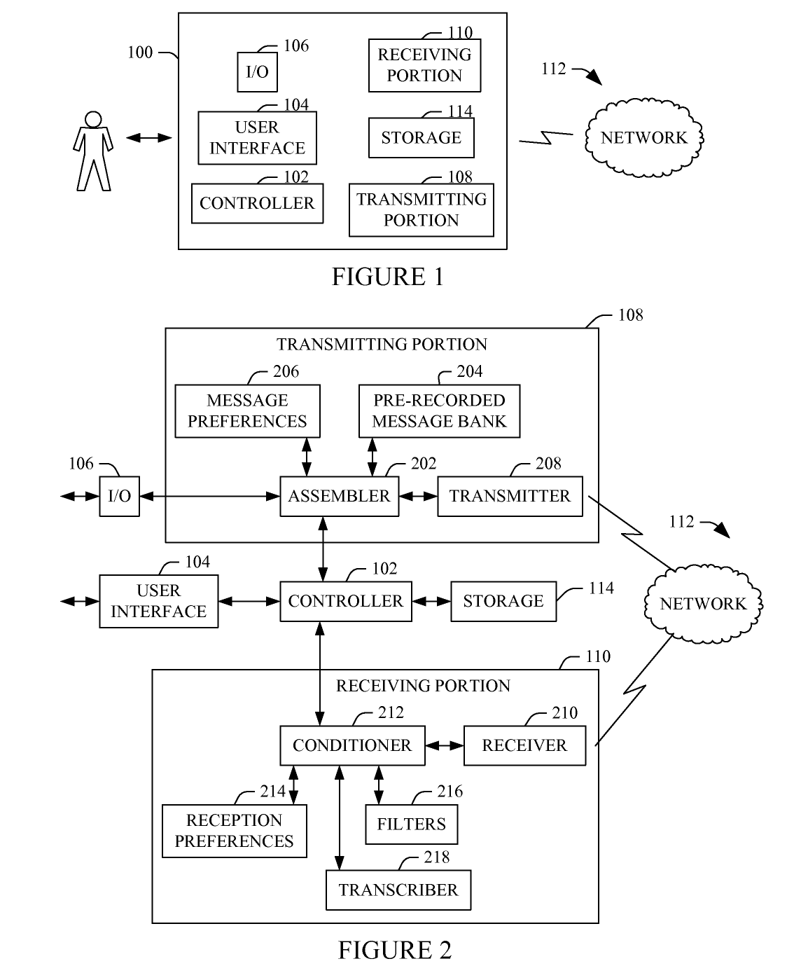

Initially referring to FIG. 1, a wireless mobile device 100 is illustrated. The wireless mobile device 100 may include, be part of, and/or work in connection with various mobile communication devices including, but not limited to, a cellular telephone, a smartphone, a softphone, a personal data assistant, a mobile computer, and the like.

The illustrated wireless mobile device 100 includes a controller 102 that controls operation of the device 100. For instance, the controller 102 may be used to supply (or remove) power to various components of the device 100 to activate (or deactivate) such components. In another instance, the controller 102 may be used to facilitate generating and/or transmitting an outgoing message. For example, the controller 102 may run program code that launches a message editing service or the like of the device 100. In another example, the controller 102 may communicate with a message editing service or the like executing on a server of the network. In yet another instance, the controller 102 may be used to invoke reception and/or presentation of an incoming message. In yet another instance, the controller 102 may be used to execute, or run, one or more applications for the device 100. Such applications may include editing, presentation, automatic reply, archive, etc. applications. It is to be appreciated that the above examples are provided for illustrative purposes and are not inclusive.

The illustrated wireless mobile device 100 further includes a user interface 104, which can be used by a user to operate (e.g., turn on/off, generate a message, send a message, receive a message, present a message, etc.) the wireless mobile device 100. As such, the user interface 104 may include or be in communication with a keyboard, a keypad, a touch screen, a digital pen, a microphone and/or other input component, and a display, a speaker, a light, and/or other output component.

The illustrated wireless mobile device 100 further includes an input/output interface (I/O) 106 that can be used receive and convey data to and from the device 100. For example, the I/O 106 may include a Universal Serial Bus (USB) port or other communications port such as a FireWire port, a parallel port, a serial (com) port, an infrared (IR) port, an optical port, a radio frequency (RF) port, a global positioning (GPS) port, and/or the like that can be used to receive and/or convey data. Such communication may be with another wireless mobile device, a computer, an external hard drive, portable memory, a database, etc.

The wireless mobile device 100 is shown as further including transmitting portion 108 and receiving portion 110. The transmitting portion 108 is used to transmit data, whereas the receiving portion 110 is used to receive data. Although the transmitting and receiving portions 108 and 110 are shown as separate components, it is to be appreciated that they may be part of the same component, such as a transceiver. Suitable messages include a telephone call, a text message, an email, an instant message, and the like, and/or a message that includes one or more sub-messages. For example, each message may be a parent message that includes one or more child (sub) messages. In turn, each child message may include one or more sub-messages. As such, various degrees of sub-message nesting may be used with each parent message.

In this example, the wireless mobile device 100 is in communication with a network 112. The network 112 may include a cellular, a Bluetooth, a WIMAX, a WIFI, a Zigbee, and/or other network, including a large area network (LAN), a wide are network (WAN), a personal are network (PAN), and the like. The network 112 may also be in communication with and/or include a private branch exchange (PBX), a public switched telephone network (PSTN), the Internet, a server (e.g., a voicemail server, an email server, text message server, etc.), and the like. As shown, communication between the wireless mobile device 100 and the network 112 may be bidirectional. However, in other examples the communication may be unidirectional, either from the wireless mobile device 100 to the network 112 or from the network 112 to the wireless mobile device 100.

A storage component 114 of the wireless mobile device 100 can be used to store various data. For example, the storage component 114 can be used to store application code, one or more messages and/or sub-messages, one or more pre-recorded messages and/or sub-messages, user preferences, one or more files, one or more notification about an available message, etc.

Turning to FIG. 2, a non-limiting example of suitable transmitting and receiving portions 108 and 110 are illustrated in connection with the user interface 104, the I/O 106, and the network 112. As shown, the transmitting portion 108 includes an assembler 202, a pre-recorded message bank 204, a message preference bank 206, and a transmitter 208.

The assembler 202 assembles a message to be transmitted. Such a message may be a single message or include a plurality of nested sub-messages. For example, in one instance the message may include a single audio message, while in another instance the message may include two or more sub-messages, each including, for example, audio (e.g., voicemail, an MP3, etc.), an image (e.g., JPEG, TIFF, BMAP, etc.), video (e.g., MPG, AVI, etc.), an alphanumeric character, a hyperlink, a URL, a computer readable instruction, a computer executable instruction, etc. For example, a message from an advertiser may include a first sub-message that includes the jingle for the advertiser, a second sub-message that includes an audio message from the advertiser, a third sub-message that includes a coupon for an item being advertised, etc. In another example, a first sub-message may include a personalized background and a second messages may include a voicemail for the recipient.

The pre-recorded message bank 204 can store one or more pre-recorded messages, including sub-messages. Such a message may be composed by a user via the user interface 104, uploaded via the I/O 106, and/or otherwise obtained. In one non-limiting instance, a pre-recorded sub-message includes a message for a single transmission. In another non-limiting instance, a pre-recorded sub-message includes a message that can be transmitted along with one or more message transmissions. By way of non-limiting example, a particular sub-message may be used as a background, a signature, a greeting, etc. audio and/or visual message that is selectively included with each message transmission. Additionally or alternatively, a pre-recorded sub-message may be stored at or by the network 112 such as at a server of the network 112. In such an instance, the network may determine when and how a pre-recorded sub-message is sent and/or included with a message. By way of non-limiting example, the network may decide to send a pre-recorded sub-message based on a condition being satisfied and such a pre-recorded sub-message may be sent before, with, or after the message is obtained by the user.

Each sub-message may be tagged or associated with corresponding indicia that identifies a type of the sub-message. For example, first indicia may indicate that a sub-message includes an audio message, second indicia may indicate a sub-message includes a text message, third indicia may indicate a sub-message includes a digital image message, fourth indicia may indicate a sub-message includes a video message, fifth indicia may indicate a sub-message includes a signature message, sixth indicia may indicate location information (e.g., GPS related information) for a sub-message, seventh indicia may indicate recipient and/or user information, eighth indicia may indicate the importance (e.g., high, medium, low, etc.) of the message, etc. In addition, one or more of the sub-messages may be password protected, encrypted, encoded, or the like. Additionally or alternatively, the parent message, including all the sub-messages, may be password protected, encrypted, encoded, or the like.

The message preference bank 206 can store message assembly preferences. For instance, the preference bank 206 may store a preference that indicates that a particular sub-message be automatically sent along when the user invokes transmission of another sub-message. Such a sub-message may be a background, a voice signature, a greeting, an advertisement, or other information indicative of the sender. When the sub-message is stored at the network, the preference can be provided to and/or stored at the network 112. In another instance, the preference bank 206 may store priority information that indicates an ordering of sub-messages in a message, for example, by type and/or importance. In another instance, the preference bank 206 may store a preference that indicates how the user desires the sub-message to be presented to the user. For example, the user may desire that an audio signature message be presented concurrently with one or more other messages such as a main message. The preference may indicate that the signature be played as a background message while the other message is concurrently presented. This may cause the signature sub-message to be presented at a relatively lower volume level with respect to the other message. In another instance, the preference bank 206 may store a preference that is based on a recipient's profile and/or information about the recipient.

The message transmitter 208 transmits the message (which may include a single message or two or more sub-messages) to the network 112 that can add one or more other sub-messages with the message and/or remove one or more sub-messages. As such, the recipient may or may not receive the original message. Sub-messages may be included or removed based on various criteria and/or conditions, such as location, day, time, recipient authorization, device configuration, network configuration, etc. It is to be appreciated that one or more messages can be stored on the network 112.

The receiving portion 110 includes a receiver 210, a message conditioner 212, a message reception preference bank 214, a filter bank 216, and a transcriber 218.

The receiver 210 receives incoming messages. In one instance, the incoming message indicates that another mobile wireless device is attempting to establish communication with the wireless mobile device 100, for example, via a phone call. In another instance, the incoming message may indicate that there is a message for the user at the network 112. Information about the incoming message can be provided to the user via the user interface 104 through visual, audible, tactile, and/or other indicators. The information may include a date and/or time the message was sent, a data and/or time the message was received by the network 112 (which may be different from the time the message is transmitted), a data and/or time of the notification (which may be different from the time the message is received by the network), an indication as to whether the network 112 modified the message, an indication as to whether the entire message or a sub-set of the sub-messages are available to the user, an indication as to whether the message is a location-based message, a summary of one or more of the sub-messages, sender information, etc. It is to be appreciated that the notification may be sent upon satisfaction of a condition, for example, lapse of a pre-set delay, the location of the recipient, etc.

The user may respond by transmitting a signal indicative of a desired action. For instance, the user may respond by having the transmitting portion 108 send a signal that indicates a communication channel between the device 100 and the network 112 should be opened so that the user may obtain the message. In one instance, the signal may also invoke the network 112 to send a notification to one or more other similar or different networks that will work in conjunction to get the message to the recipient. It may also use one or more different network protocols. For example, an advertiser may send out a message to the device 100, and the delivery of the message or a notification that the message is available may be conditioned to be delivered, for example, when the advertiser is available on the network so that the recipient of the message can communicate with the advertiser, if desired. In another example, the signal indicates that the message should be ignored and/or discarded.

A message conditioner 212 conditions a received incoming message for presentation. A message reception preference bank 214 stores preferences that may be used by the conditioner 212. For example, the conditioner 212 may re-order sub-messages in response to a preference. In another example, the conditioner 212 may present the sub-messages based on a preference. For example, a preference may indicate that a background or signature sub-messages should be ignored. In another example, a preference may indicate a volume level for an audio background or signature sub-message. In another example, a preference may indicate that a message should be automatically sent to the transmitting device to confirm receipt of the message. The preferences may also be sent to and/or stored at the network 112, and the network may perform the messaging conditioning based on the preferences.

A filter 216 stores filters that can be used by the conditioner 212 to alter, modify, combine, remove, discard, and/or ignore sub-messages. For instance, a location-based filter may remove sub-messages based on the location of the wireless mobile device 100 receiving the message. For example, the received message may include a first sub-message that is associated with first indicia that is indicative of a first location, a second sub-message that is associated with second indicia that is indicative of a second location, . . . , an Nth sub-message that is associated with Nth indicia that is indicative of a Nth location. The wireless mobile device 100 may include global positioning capabilities that can be used to determine the location of the wireless mobile device. The location based filter can be used to accept sub-messages with indicia location that matches the wireless mobile device 100 location and reject the other sub-messages. Other filters, including user, time, date, size, etc. filters are also contemplated. Additionally or alternatively, the filter 216 may be implemented at the network 112.

An optional transcriber 218 is used to transcribe audio messages. In one non-limiting instance, this includes converting one or more voicemails and/or audio sub-messages to a text based message, in series and/or in parallel. In one instance, this may include converting the audio to a text message that is delivered to the recipient. In another instance, this may include converting the audio to an instant message, for example, when the sender is logged on to instant messaging when the recipient attempts to obtain the message. A preference can be set in the preference bank 214 so that this is automatically performed. The original audio message may be kept or discarded.

Alternatively, the user can manually select to have an audio message transcribed. In addition, the user can transmit a signal that indicates audio messages should be transcribed and that only transcribed sub-messages should be conveyed to the receiving wireless mobile device 100. The signal may also indicate that the service provider use a third party trusted transcription service or the like to transcribe an audio message and verify the transcription. Additionally or alternatively, the network may transcribe based on a condition such as a location, relevancy, an action, etc. The condition may also be used to determine if the parent message or a sub-message should be delivered with the other sub-messages.

The received message, including at least one of the sub-messages is retrieved by the user via the user interface 104. As noted above, the message and/or one or more of the sub-messages may be password protected, encrypted, encoded, etc. As such, the user may be prompted for authorization information such as a password, a fingerprint, an iris scan, voice, other biological and/or non-biological related information. In one non-limiting instance, a sub-message may indicate that one of the other sub-messages is for a different person such as a spouse or child. As such, the recipient may able to receive a sub-message, but cannot retrieve the content of the sub-message without the person authorized to retrieve the content.

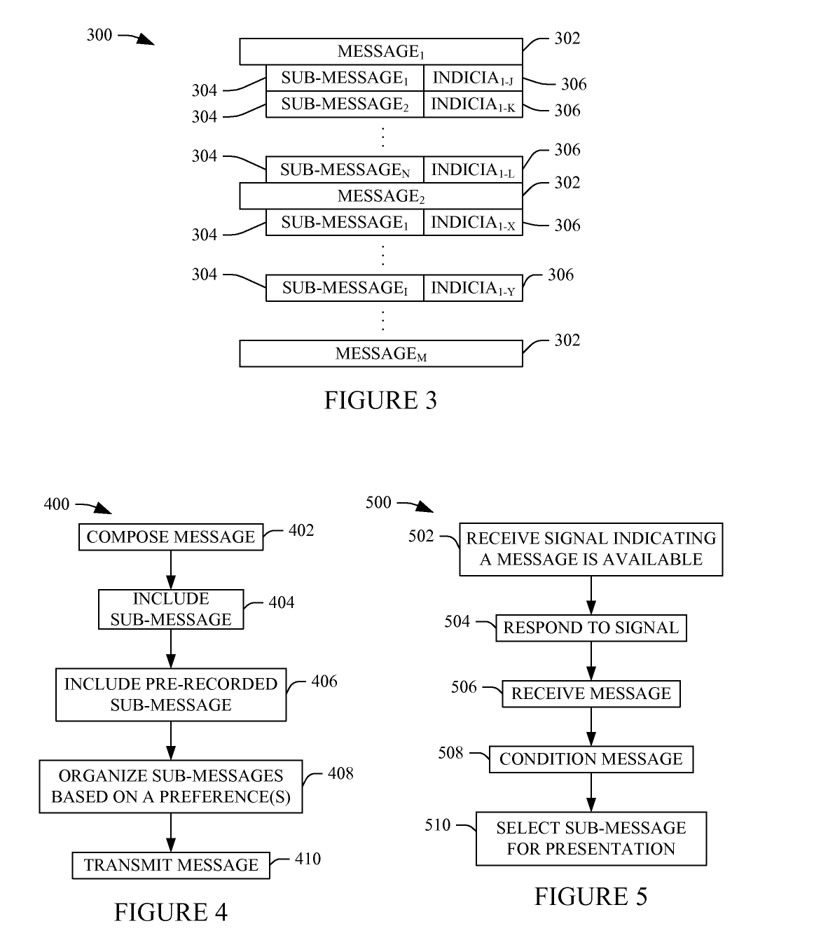

FIG. 3 illustrates a non-limiting example of a message data structure 300. It is to be understood that the data structure 300 is provided for explanatory purposes and is not limiting. The data structure 300 includes first fields 302 for indicia that uniquely identifies each message to the recipient. This may include information such as an indication of the message sender, the time, the date, a subject, a title, an identification number, etc.

The data structure 300 further includes an array of fields 302 for different sub-messages. For each sub-message, a field 304 includes indicia such as one or more parameters indicative of the sub-message. The parameters provide information such as location information, type information, importance, etc. as discussed above. It is to be appreciated that the number of sub-messages for each message may be the same or different, and that the number of parameters for each sub-message may be the same or different.

It is to be understood that alternative structures are also contemplated. For instance, the message may include a header with various information about the sub-messages. In another instance, a separate message that includes such information is received before, during, or after reception of the message. In another instance, each sub-message includes this information.

It is to be appreciated that the content of the data structure 300 can be variously presented to the user. For instance, each message may be rolled up so that the user of the wireless mobile device 100 only sees some or all of the information in the first field 302. Upon selecting a particular message, that message may be unrolled so that the user can see the information in the remaining fields. For messages with lots of sub-messages, the text may automatically adjust in size or a scroll bar may appear so that the user can see all of the sub-messages. The user may then select any sub-message. The above allows the user to select messages and sub-messages in any order. Likewise, the user can delete messages and/or sub-messages in any order.

FIG. 4 illustrates a flow diagram 400 for transmitting a wireless message that includes a plurality of sub-messages. At 402, a user indicates a desire to compose a message for transmission to another. At 404, the user selects one or more sub-messages to include with the message. As described herein, the sub-message may include audio, text, an image, video, a hyperlink, etc. In addition, each sub-message may include information that identifies the type of message, a location, an importance, and/or other information. At 406, default pre-recorded sub-messages, if any, are included. For instance, the user may pre-record a greeting and configure the wireless mobile device 100 to automatically include the greeting with each composed message. At 408, the sub-messages are organized based on the user preferences as described above. At 410, the message is transmitted.

FIG. 5 illustrates a flow diagram 500 for receiving a wireless message that includes a plurality of sub-messages. At 502, a signal indicating that a message is available is received. At 504, a signal indicating an action is transmitted in response. As noted above, in one instance the signal may indicate that the message is to be received, discarded, or altered and received. For the latter case, the signal may indicate that some of the sub-messages should be discarded while other of the sub-messages should be received. The decision may be based on various factors including, but not limited to, the location of the recipient, the content of a sub-message, the sender, etc. At 506, the message is received. At 508, the message is conditioned for presentation to the recipient. For instance, one or more of the sub-messages may be re-ordered, one or more of the sub-messages may be removed, the presentation of one or more of the sub-messages may be altered, etc. At 510, the user selects a message and sub-message for presentation.

Although the above has been described with reference to wireless mobile technology, it is to be appreciated that wired technology is also contemplated. By way of non-limiting example, a computing system (e.g., a main frame) of a corporation, business, or the like, may employ the above described components to generate, transmit, receive, and/or present one or more messages and/or sub-messages thereof.

The foregoing description has been presented for purposes of illustration; it is not intended to be exhaustive or limiting. Modifications and/or variations may occur to others upon reading the description and intended to be included within the scope of the claimed subject matter or equivalents thereof.

I claim:

1. A wireless mobile communication device, comprising:
a message assembler that assembles a message having a plurality of sub-messages, wherein each of the sub-messages is associated with corresponding indicia that indicates at least a type of the sub-message;
a preference bank that stores message preferences, wherein at least one of the message preferences indicates a manner in which a sender of the message desires the sub-messages to be presented to a recipient of the message; and
a message transmitter that transmits the message for receipt by the recipient.

2. The device of claim 1, wherein at least two of the sub-messages are different types of messages.

3. The device of claim 1, wherein a sub-message includes one of audio, video, text, an image, and a hyperlink.

4. The device of claim 1, wherein one of the sub-messages is used as a signature of the sender, wherein the signature is automatically transmitted with the message.

5. The device of claim 1, wherein the preference bank includes a preference that indicates that two or more of the sub-messages are to be concurrently presented to the recipient.

6. The device of claim 1, further including a message bank that stores pre-recorded messages, wherein at least one of the sub-messages is pre-recorded and stored in the message bank, wherein the assembler automatically includes the at least one of the pre-recorded sub-messages based on a preference.

7. The device of claim 1, wherein at least one of the sub-messages is pre-recorded and stored on a remote server, wherein the pre-recorded sub-message is automatically transmitted to the recipient with the message.

8. The device of claim 1, wherein the mobile communication device is part of a cellular telephone, a smartphone, or a softphone.

9. A wireless mobile communication device, comprising:
a receiver that receives one or more messages, each having a plurality of sub-messages, wherein each of the sub-messages is associated with corresponding indicia that indicates at least a type of the sub-message;
a preference bank that stores message preferences, wherein at least one of the message preferences indicates a manner in which the sub-messages are to be presented;
a conditioner that conditions the received sub-messages based on the at least one preference; and
a user interface that presents the conditioned sub-messages.

10. The device of claim 9, wherein the user interface provides for selecting any sub-message of any message for presentation in any order.

11. The device of claim 9, wherein the conditioner filters the sub-messages based on location indicia associated with each sub-message.

12. The device of claim 9, wherein a sub-message includes one of audio, video, text, an image, and a hyperlink.

13. The device of claim 9, wherein the user interface concurrently presents two or more of the sub-messages based on a preference.

14. The device of claim 9, further including a transcriber that transcribes audio sub-messages.

15. The device of claim 1, wherein the mobile communication device is part of a cellular telephone, a smartphone, or a softphone.

16. A method, comprising:
generating a message that includes a plurality of independent sub-messages;
organizing the sub-messages based on a preference; and
wirelessly transmitting the message, using a wireless mobile device, for reception by a recipient.

17. The method of claim 16, wherein the wireless mobile device is a cellular telephone, a smartphone, or a softphone.

18. A method, comprising:
receiving a plurality of messages with a wireless mobile device, wherein each of the plurality of messages includes a plurality of sub-messages;
identifying one of the plurality of messages;
identifying a sub-message of the message for presentation;
identifying a presentation preference for the identified sub-message; and
presenting the sub-message based on the identified preference.

19. The method of claim 18, wherein the wireless mobile device is a cellular telephone, a smartphone, or a softphone.

20. A computer readable medium having a message data structure that includes a plurality of messages and a plurality of sub-messages for each of the plurality of messages, wherein the message data structure is wirelessly transmitted by a wireless mobile communication device, the message data structure comprising:
first fields adapted to include data that uniquely identifies reception of one of the plurality of messages;
a plurality of sub-message fields corresponding to each of the first fields, wherein each of the plurality of sub-message fields is configured to include a different sub-message;
for each of the plurality of sub-message fields, an information field configured to include one or more parameters indicative of the sub-message.
